(19) United States
(12) Patent Application Publication
(10) Pub. No.: US 2018/0296015 A1
(43) Pub. Date: Oct. 18, 2018

(54) Bendable hanging apparatus

(71) Applicant: MICHAEL KELLY TIBBETTS, GRAND ISLAND, NE (US)

(72) Inventor: MICHAEL KELLY TIBBETTS, GRAND ISLAND, NE (US)

(21) Appl. No.: 15/916,185

(22) Filed: Mar. 8, 2018

Related U.S. Application Data
(60) Provisional application No. 62/484,764, filed on Apr. 12, 2017.

(51) Int. Cl. A47G 29/00; F16B 45/00; B05B 15/60

(52) U.S. Cl. CPC A47G 29/00; A47G 29/08; B05B 15/60; F16B 45/00

(57) ABSTRACT

Described is a hanging device for hanging equipment, comprising of a coated material bent in a “S”, “P”, or “L” shape or similar shape. The apparatus comprises of two hooks on the first end to hang multiple items and a looped second end to hang off of multiple structures.

### BACKGROUND

There are other prior art and designs of storage devices that exist for hanging equipment, but none is similar in scope and overall design. For example, the removable airbrush hanger system Mr. Silverman constructed (U.S. Ser. No. 7/641,058) needs to be permanently screwed into a wall. There is a specific need for a transportable hanger that can be mounted and remounted without being permanent in different locations and fits multiple different kinds of equipment, apparatus, airbrushes, or spray guns. Applicant's bendable hanging apparatus is intended to cure previously mentioned defects in prior hanging systems.

### SUMMARY

This apparatus provided a safe and secure way to hang my airbrush close to wherever I needed the equipment to be. Another point of the invention is to make people's lives more organized and reduce stress from unnecessary mishaps.

Some advantages are: (a) you can hang different objects or equipment at an indoor or outdoor location and from almost any object. Hang it from a nail off of two different locations on the hanger; (b) wrap it around a vertical cylinder shaped object; (c) use the “S” shaped hanger to hold your cell phone to view the internet. This is a nice selling point since so many people, including myself, use their own phone as a mini TV; (d) the hangers are compact and when not in use do not take up much room and can be stored where they are used in most cases; (e) the hanger prevents unexpected and unnecessary repairs to your airbrush or spray gun; and (f) twelve years of field testing as an airbrush hanger.

### BRIEF DESCRIPTION OF DRAWINGS

The numerous advantages of the disclosure may be better understood by those skilled in the art by reference to the accompanying figures in which:

FIG. 1 depicts a front view of the “S” shaped hanger according to the present invention;

FIG. 2 depicts side view of the “s” shaped hanger of FIG. 1;

FIG. 3 depicts the back view of FIG. 1;

FIG. 4 depicts front view of the “L” shaped hanger by re-bending FIG. 1, 22 upwards to form the “L” shape;

FIG. 5 depicts the side view of FIG. 4;

FIG. 6 depicts the back view of FIG. 4;

FIG. 7 depicts the airbrush hanger in use as the standard “S” shape out of a box or similar structure;

FIG. 8 depicts how to use the standard “S” shape to hang automotive spray gun;

FIG. 9 depicts how to use hanger hung on a screw in the wall to hang an airbrush;

FIG. 10 depicts how to bend the larger sized hanger version of FIG. 1 into a “P” shape to hang around a camera tripod. (The camera tripod is displayed in the figure for explanation of how to bend the “P” shape);

FIG. 11 depicts how to use the hanger as a cell phone holder;

FIG. 12 depicts how to hang cleaning brushes;

FIG. 13 depicts how to hang jewelry;

FIG. 14 depicts how to hang a hat from a box or similar structure;

FIG. 15 depicts how to hang an air hose, cord, or similar apparatus to a multiple of “S” shaped hangers;

FIG. 16 depicts the same as FIG. 15 but with nothing hanging from the hangers; and

FIG. 17 depicts the same concept as FIG. 15, the only difference is that the hangers are in the “L” shape.

### DETAILED DESCRIPTION

Reference will now be made in detail to the subject matter disclosed, which is illustrated in the accompanying drawings.

Before any embodiments of the disclosure are explained in detail, it is to be understood that the embodiments may not be limited in application per the details of the structure or function as set forth in the following descriptions or illustrated in the figures. Different embodiments may be capable of being practiced or carried out in various ways. Also, it is to be understood that the phraseology and terminology used herein is for description and should not be regarded as limiting. The use of terms such as “including,” “comprising,” or “having” and variations thereof herein are generally meant to encompass the item listed thereafter and equivalents thereof as well as additional items. Further, unless otherwise noted, technical terms may be used according to conventional usage. It is further contemplated that like reference numbers may describe similar components.

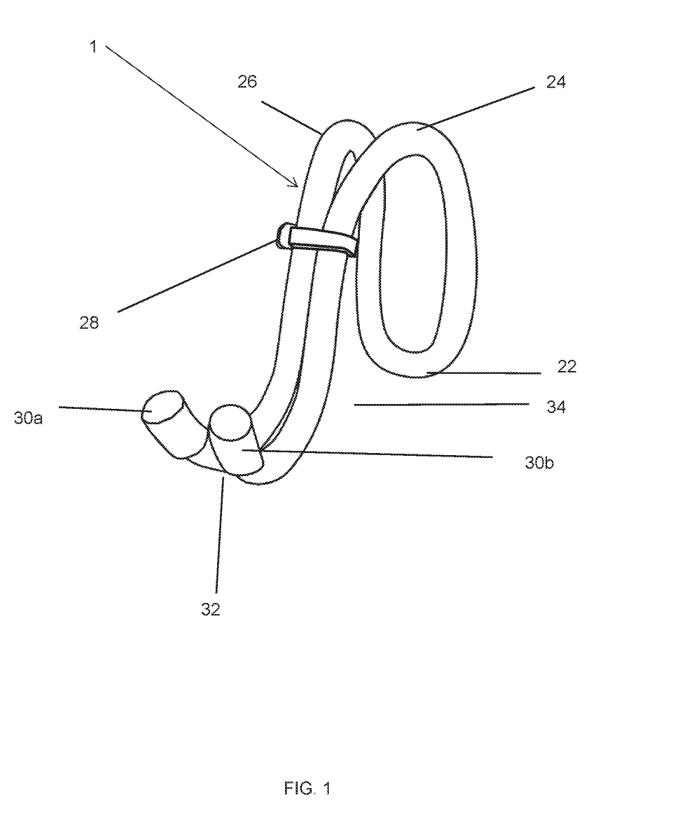

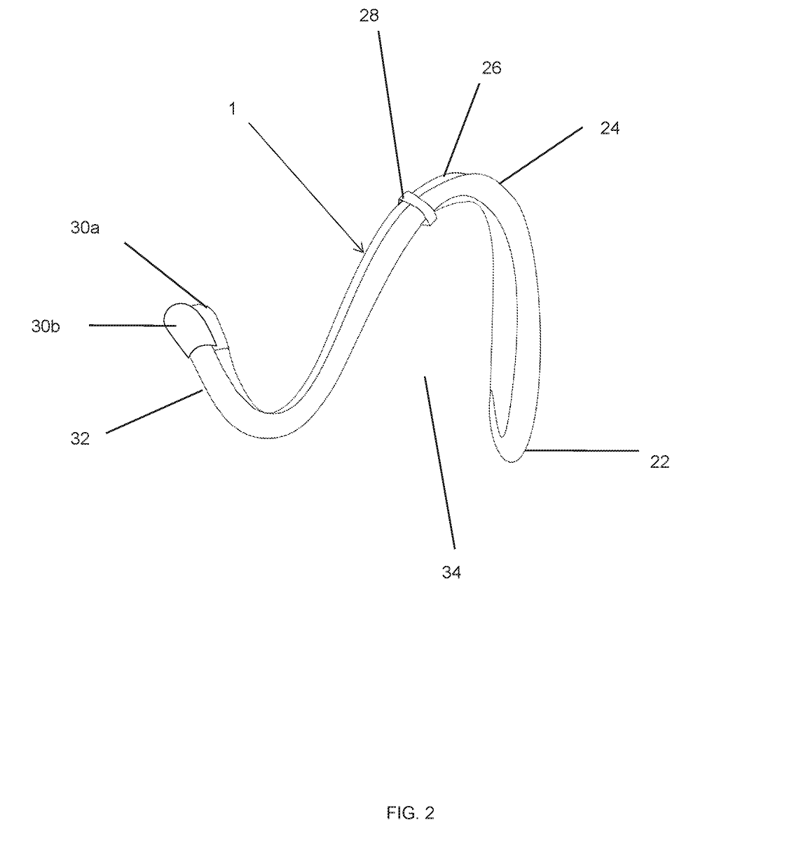

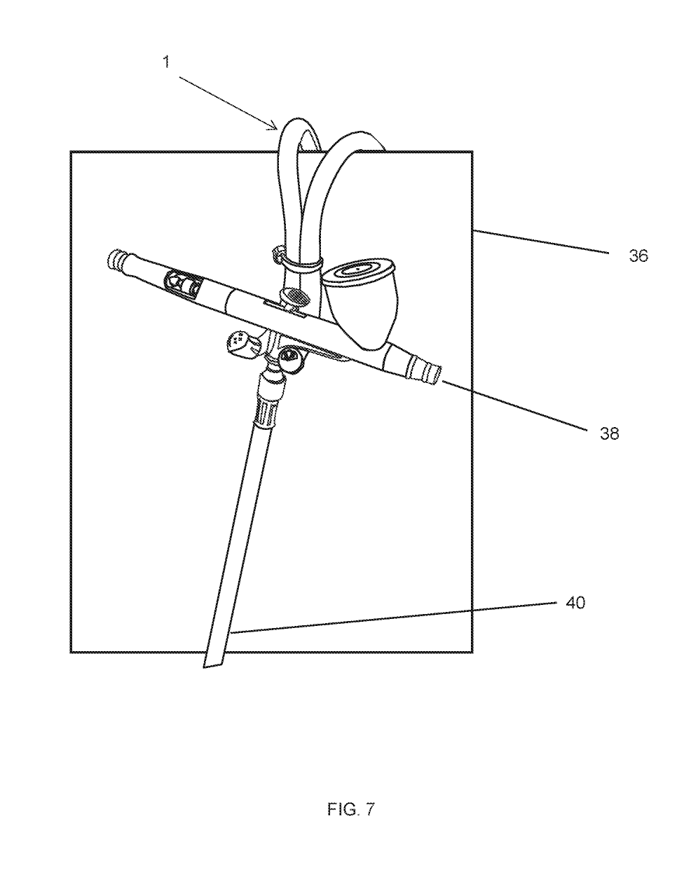

Referring to FIGS. 1-6 and 10, the preferred embodiment will be discussed as used for holding spray paint equipment. Referring to FIGS. 7-9 and 11-17, depicts how to hang apparatus from the hanger in different embodiments.

Referring specifically to FIGS. 1-3, which shows the front, side, and back view of an embodiment of the hanging device of the present invention of FIG. 1. The present invention comprises a looped piece of pliable material 22 having two curved pieces that extend upward 24, 26 and then bend back down and through a plastic fastener 28, wherein said material 24, 26 extends down and curves back upward to form two hooks with plastic caps or rubber coating at the ends 30a, 30b, the completed product produces a space 32 between 30a and 30b. The space is adequate for several different apparatuses to hang between the ends while the apparatus is suspended off of the hooks, such as an air hose or apparatus handle. 34 represents the area between the looped end 22 and the two pieces bent down 24, 26, allowing the user to place the looped section inside a box and hang the hooks 30a, 30b outside of said box for use as a moveable hanger.

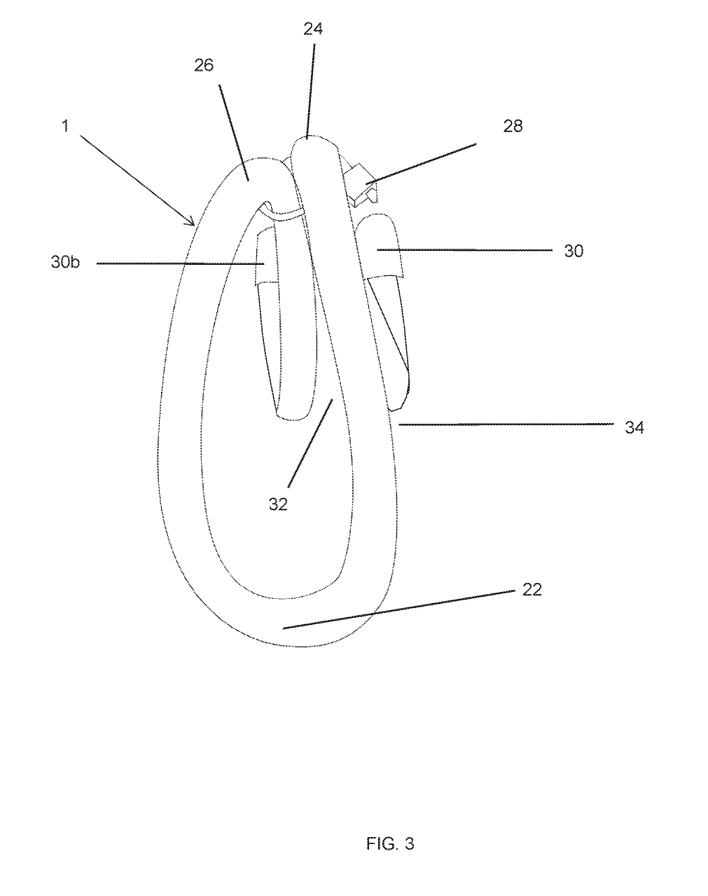

In FIG. 3, loop 22 is placed inside of a box, drawer, vertical handle or similar apparatus the hanger can slide over to suspend down to be used as a hanger.

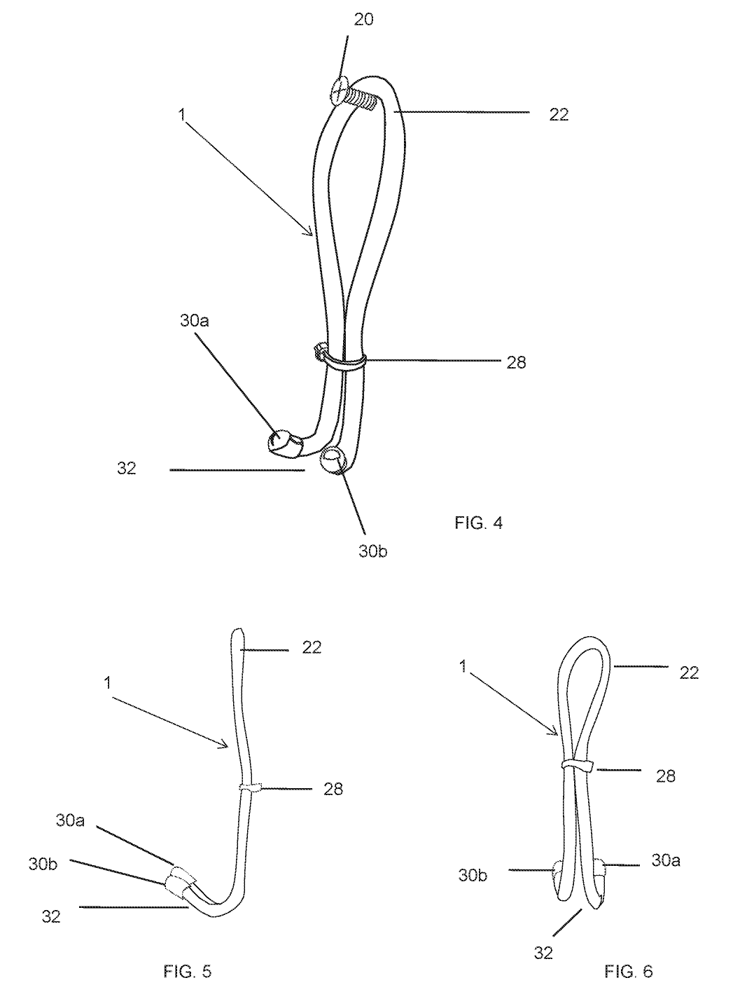

FIGS. 4-6 show the front, side, and back view of the “L” shape. The “L” is formed when the back of the hanger 22 is bent upwards so that the loop 22 is now vertical and can be placed over a screw 20. The plastic strap 28 secures the embodiment. The said embodiment is now in the “L” shape and the hooked bottom 30a, 30b are ready to hang an apparatus.

FIG. 7 represents how the present invention 1 hangs from a box 36. The top of the hanger 1 is protruding out of the box 36. The apparatus or in this case airbrush 38, hangs from the hanger 1. The airbrush is attached to an air hose 40.

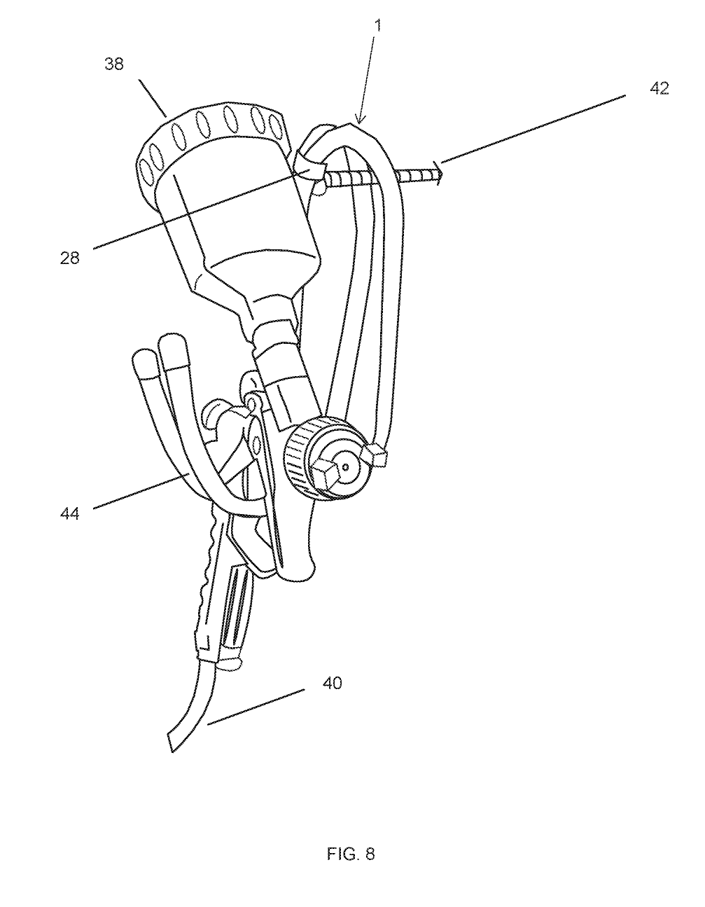

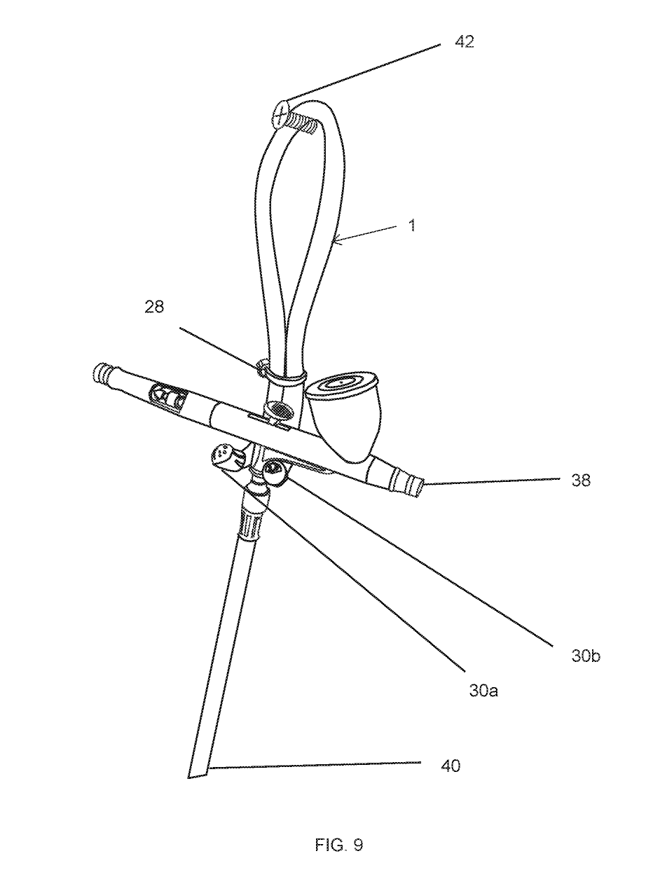

FIG. 8 represents the larger sized “S” hanger 1 hanging a bigger apparatus 38, such as an automotive spray gun, cord, hammer, or any other type of apparatus that fits the hanger and is suspended from a screw or nail or similar style apparatus 42 is placed under the plastic strap 28 to suspend the hanger 1 to hold the spray gun 38. Now referring 44 in FIG. 8 displays where the hooks come out and make a space to support an apparatus. FIG. 8, 40 is the air hose. This example is not recommended to use as shown. A more adequate method of using the hanger to hang an apparatus from a nail or screw is the method outlined in FIG. 9.

FIG. 9 represents the current invention FIG. 1 bent into the “L” shape hanger 1 to suspend the hanger from a nail or screw 42. FIG. 9 is also outlined in FIGS. 4, 5, 6 and 17. Shown in FIG. 9 is the plastic strap 28, the apparatus 38, the end of the embodiment with plastic caps 30a, 30b and the air hose 40.

FIG. 10 shows the large size of the current invention 1 of FIG. 1 bent into a “P” shape. The looped end 22 goes in one hand and the opposite end of the hanger 30a and 30b with hooks goes in your other hand and gets bent around a vertical top pole 56 on a camera tripod or similar type apparatus 58. The arms of the hanger 24, 26 and the capped ends 30a and 30b are pulled through the loop in the end of the hanger 22. The hooks are pulled through and down to an adequate length to allow the hooks to hang an apparatus 38. The space between the hanger hooks 30a and 30b is 32.

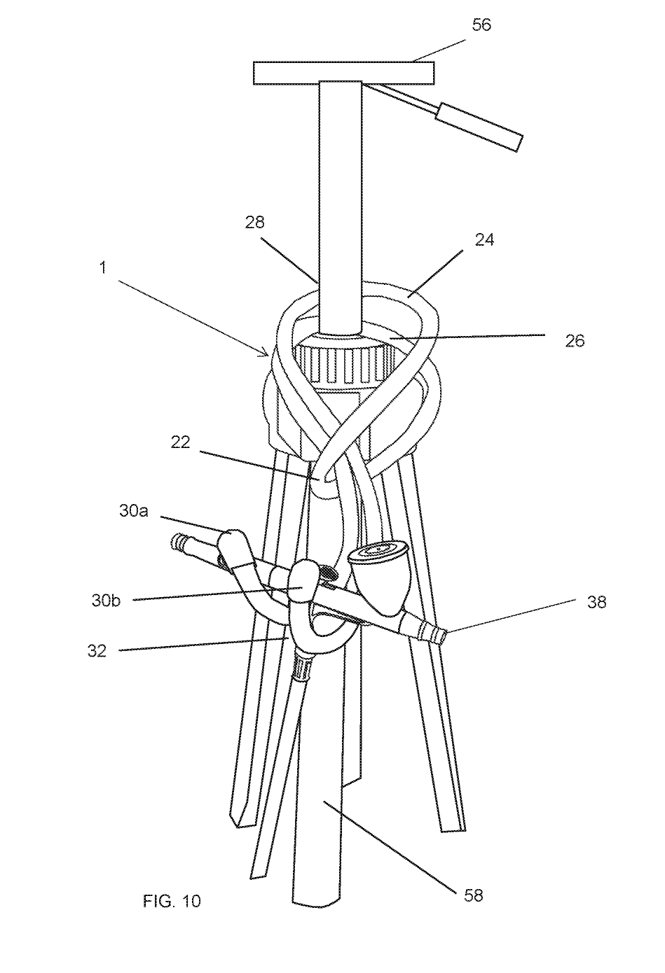

FIG. 11 refers to FIG. 1 in the “S” shape bend. 1 is the top of the back of the hanger as it is placed inside of a roll of tape 46 for extra support. The roll of tape is not need to accomplish the same task but does add extra support and stability for those people that worry about their phones excessively. 30a, 30b points to the end caps of the hooked end of the hanger, 38 shows a cell phone or similar type apparatus that sits on a flat surface and leans against the hanger 1 for support for viewing a cell phone 38.

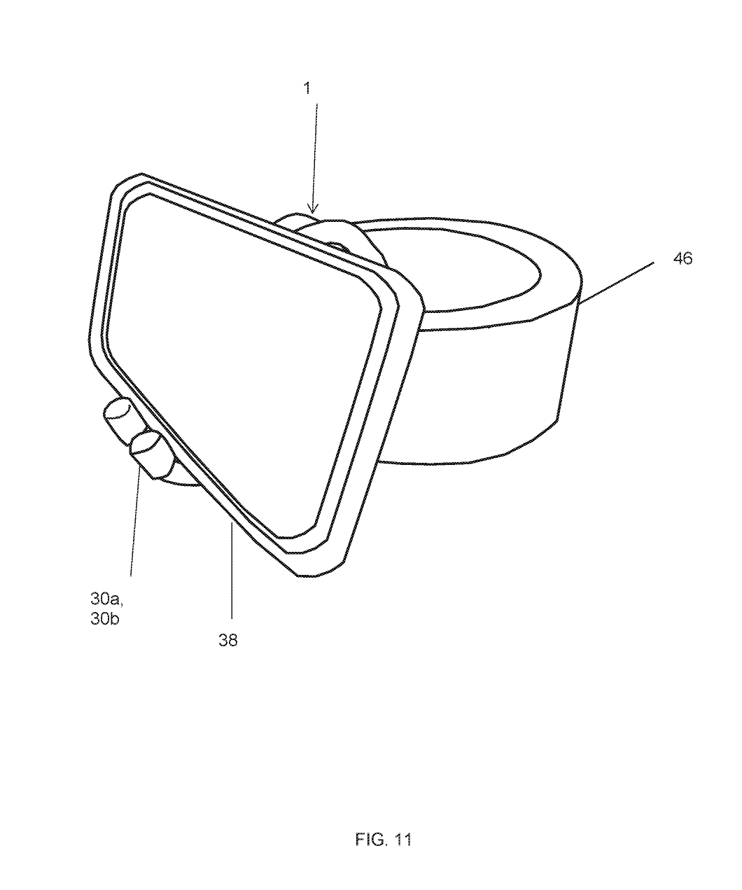

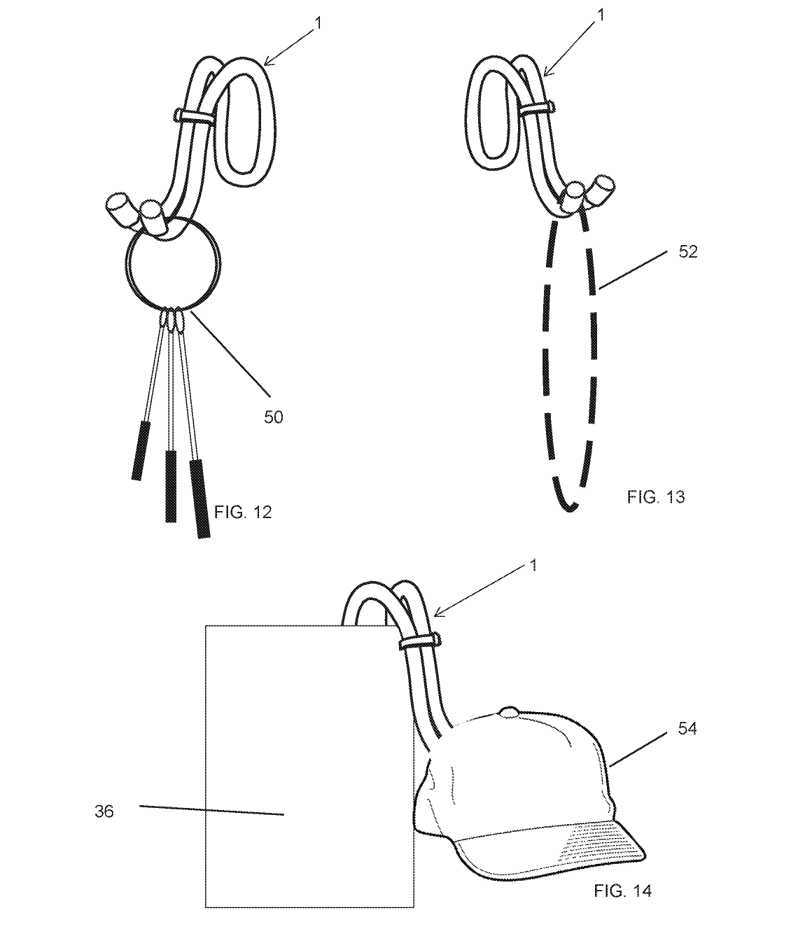

FIGS. 12-14 represent FIG. 1 in the “S” shape hanging different items such as cleaning brushes FIG. 12, 50; or a necklace FIG. 13, 52. FIG. 14 represents FIG. 1 in the “S” shape hanging out of a box 36 holding a hat 54.

FIG. 15 shows FIG. 1 used with multiple hangers to suspend an air hose, electric line, pipe or similar type apparatus 60 overhead, off of boxes 36 or any style apparatus 62 that will suspend the hangers in the “S” style 1 using multiples of two or more.

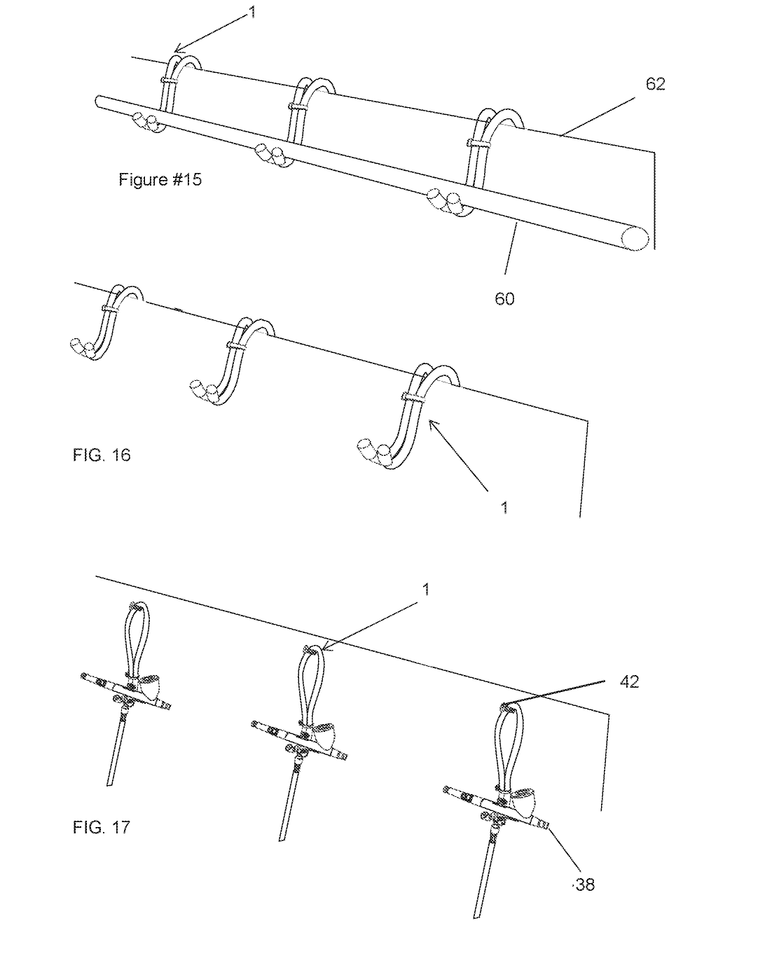

FIG. 16 refers to FIG. 15 without the hangers 1 suspending an apparatus.

FIG. 17 shows how multiple hangers 1 can also hang multiple automotive airbrushes with the cup on the top of the airbrush or similar type apparatus, structure, or apparatus 38. The hanger is suspended by a screw or nail 42. A wall, board, or similar type structure is described as 62 in FIG. 17.

1-8. (canceled)

9. A universal hanger, comprising:
a main body portion including two rods on which an apparatus is to be hung, wherein the main body portion is curved;
a strap configured to secure the two rods; and
hook portions coupled to each rod.

10. The universal hanger as recited in claim 9, wherein the hook portions are configured to hang a multitude of devices.

11. The universal hanger as recited in claim 9, wherein the curved portion is configured to hang on a plurality of devices.

12. The universal hanger as recited in claim 11, wherein the main body portion is configured to hang off a multitude of different vertical apparatus.

13. A universal hanger, comprising:
a main body portion including two rods on which an apparatus to be hung which form a loop configured to secure to a post;
a strap configured to secure the two rods; and
hook portions coupled to each rod.

14. The universal hanger as recited in claim 13, wherein the hook portions are configured to hang a multitude of devices.

15. The universal hanger as recited in claim 13, wherein the main body portion is configured to hang off a multitude of different vertical apparatus.

16. The universal hanger as recited in claim 13, wherein the hook portions are configured to be placed between the rods below the strap.

17. A universal hanger, comprising: a main body portion on which an apparatus is to be hung; a first end having two rods bent upward to form hooks with plastic caps and comprise the main body portion, and a plastic strap securing the rods at an approximate center point of the embodiment, wherein the main body portion includes a second end comprising of the doubled up back side extending downward.

18. The universal hanger as recited in claim 17, wherein the main body portion includes a said side two bent in a upward direction.

19. The universal hanger as recited in claim 18, wherein the said side two rods are rotatably movable around a vertical rod as a fulcrum and brought through itself, and extending the first end hooks to be used as a hanging device.

20. The universal hanger as recited in claim 17, wherein in the embodiment of the current invention can be used with multiple hangers to suspend a multitude of apparatus.

21. The universal hanger as recited in claim 18, wherein in the embodiment of the current invention can be used with multiple hangers to suspend a multitude of apparatus.

22. The universal hanger as recited in claim 17, wherein the hooked first side can hang a multitude of apparatus.

23. The universal hanger as recited in claim 17, wherein the looped second side can hang off of a multitude of different apparatus.

24. The universal hanger as recited in claim 18, wherein the hooked first side can hang a multitude of apparatus.

25. The universal hanger as recited in claim 18, wherein the looped second side can hang off of a multitude of different apparatus.

26. The universal hanger as recited in claim 19, wherein the hooked first side can hang a multitude of apparatus.

27. The universal hanger as recited in claim 19, can be used as a hanging device off of a multitude of different vertical apparatus.
